(19) United States
(12) Patent Application Publication
(10) Pub. No.: US 2026/0129591 A1
(43) Pub. Date: May 7, 2026

(54) TECHNOLOGIES FOR INCREASING OUTPUT POWER

(71) Applicant: Apple Inc., Cupertino, CA (US)

(72) Inventors: Alexander Sayenko, Munich (DE); Daniel Popp, Munich (DE); Anatoliy S. Ioffe, Sunnyvale, CA (US); Naveen Kumar R. Palle Venkata, San Diego, CA (US)

(73) Assignee: Apple Inc., Cupertino, CA (US)

(21) Appl. No.: 18/940,557

(22) Filed: Nov. 7, 2024

(51) Int. Cl. H04W 52/36; H04W 8/22; H04W 76/50; H04W 84/06

(52) U.S. Cl. CPC H04W 52/367; H04W 8/22; H04W 76/50; H04W 84/06

(57) ABSTRACT

The present application relates to devices and components, including apparatus, systems, and methods for measuring serving cell configuration. The user equipment may detect a condition, and based on the condition, it may determine a configuration associated with a set of requirements. The requirements may be associated with determining a maximum transmit power or power back-offs. The UE may determine the maximum transmit power based on the configuration. Based on the maximum transmit power, UE may perform power control or other algorithms to determine the transmit power used to transmit a signal to the network.

### TECHNICAL FIELD

This application relates generally to communication networks and, in particular, to transmit power and emission limit configurations.

### BACKGROUND

Third Generation Partnership Project (3GPP) Technical Specifications (TSs) define standards for wireless networks. These TSs describe aspects related to user plane and control plane signaling over the networks.

### BRIEF DESCRIPTION OF THE DRAWINGS

FIG. 1 illustrates a network environment in accordance with some embodiments.

FIG. 2 illustrates a power diagram in accordance with some embodiments.

FIG. 3 illustrates a configured information element in accordance with some embodiments.

FIG. 4 illustrates an operation flow/algorithmic structure in accordance with some embodiments.

FIG. 5 illustrates another operation flow/algorithmic structure in accordance with some embodiments.

FIG. 6 illustrates another operation flow/algorithmic structure in accordance with some embodiments.

FIG. 7 illustrates a user equipment in accordance with some embodiments.

FIG. 8 illustrates a network node in accordance with some embodiments.

### DETAILED DESCRIPTION

Increasing the transmit power of user equipment (UE) may provide reliable links (e.g., with satellites or non-terrestrial network nodes) by enabling the UE to transmit signals at the highest possible power levels. The robustness and reliability of the communication link are directly related to the received power at the destination (e.g., terrestrial or non-terrestrial network node). One way to increase the received power is to increase the input power and transmit at the highest available power, e.g., maximum transmit power. Two parameters contribute to determining the maximum transmit power: nominal maximum output power (defining the maximum output power of a device) and power back-off that may be an aggregate value of all the reductions to nominal maximum output power due to regulations and guidelines. For example, specific emission requirements, such as the Adjacent Channel Leakage Ratio (ACLR), may contribute to power back-off. One way to increase the received power is to temporarily relax the requirements contributing to the power back-off. For instance, in scenarios such as emergency calls, the ACLR requirement might be reduced from a stringent 30 dB ratio to 25 dB, allowing higher power transmission.

Relaxing the requirements may involve configuring both the UE and network to support these higher power levels. Network signaling can instruct the UE to increase its power based on predefined conditions, such as emergency situations or specific frequency bands. The device firmware must be capable of dynamically adjusting power levels, with predefined maximum power limits that can be increased (compared to the default levels) temporarily under relaxed conditions.

For example, in emergency call handling, the UE may automatically switch to a higher power mode when an emergency call is initiated. This can be triggered by the emergency call button or dialing an emergency number, with the device and network programmed to recognize these scenarios and adjust power levels accordingly.

In some embodiments, the UE may detect a condition (e.g., an emergency condition). The condition may trigger identifying a configuration of relaxed requirements for signal transmission associated with the detected condition. The UE may apply the configuration and determine a first maximum transmit power based on the configuration, the maximum transmit power may be higher than the maximum transmit power associated with a default configuration. The UE may determine the transmit power for a signal transmission based on the maximum transmit power and generate and transmit a signal at a power level of the determined transmit power. The UE's uplink transmission may be to a terrestrial or a non-terrestrial network node.

In some embodiments, the network may configure the UE with several configurations and activate a subset (non, some, or all of the configurations). In some instances, UE may autonomously determine an emergency condition, determine a configuration for relaxed requirements associated with the condition, and apply it. In some instances, the network may configure the association between the emergency conditions and configurations for relaxed requirements. The network may also enable or disable UE with relaxed requirements operations and may activate or deactivate the configurations for relaxed requirements at the UE.

The following detailed description refers to the accompanying drawings. The same reference numbers may be used in different drawings to identify the same or similar elements. In the following description, for purposes of explanation and not limitation, specific details are set forth, such as particular structures, architectures, interfaces, and techniques to provide a thorough understanding of the various aspects of various embodiments. However, it will be apparent to those skilled in the art having the benefit of the present disclosure that the various aspects of the various embodiments may be practiced in other examples that depart from these specific details. In certain instances, descriptions of well-known devices, circuits, and methods are omitted so as not to obscure the description of the various embodiments with unnecessary detail. For the purposes of the present document, the phrases “A/B” and “A or B” mean (A), (B), or (A and B); and the phrase “based on A” means “based at least in part on A,” for example, it could be “based solely on A” or it could be “based in part on A.”

The following is a glossary of terms that may be used in this disclosure.

The term “circuitry,” as used herein, refers to, is part of, or includes hardware components that are configured to provide the described functionality. The hardware components may include an electronic circuit, a logic circuit, a processor (shared, dedicated, or group) or memory (shared, dedicated, or group), an application-specific integrated circuit (ASIC), a field-programmable device (FPD) (e.g., a field-programmable gate array (FPGA), a programmable logic device (PLD), a complex PLD (CPLD), a high-capacity PLD (HCPLD), a structured ASIC, or a programmable system-on-a-chip (SoC)), or a digital signal processor (DSP). In some embodiments, the circuitry may execute one or more software or firmware programs to provide at least some of the described functionality. The term “circuitry” may also refer to a combination of one or more hardware elements (or a combination of circuits used in an electrical or electronic system) with the program code used to carry out the functionality of that program code. In these embodiments, the combination of hardware elements and program code may be referred to as a particular type of circuitry.

The term “processor circuitry,” or “processing circuitry,” as used herein, refers to, is part of, or includes circuitry capable of sequentially and automatically carrying out a sequence of arithmetic or logical operations, recording, storing, or transferring digital data. The term “processor circuitry” may refer to an application processor, baseband processor, central processing unit (CPU), graphics processing unit, single-core processor, dual-core processor, triple-core processor, quad-core processor, or any other device capable of executing or otherwise operating computer-executable instructions, such as program code, software modules, or functional processes.

The term “interface circuitry,” as used herein, refers to, is part of, or includes circuitry that enables the exchange of information between two or more components or devices. The term “interface circuitry” may refer to one or more hardware interfaces, for example, buses, I/O interfaces, peripheral component interfaces, and network interface cards.

The term “user equipment” or “UE” as used herein refers to a device with radio communication capabilities that may allow a user to access network resources in a communications network. The term “user equipment” or “UE” may be considered synonymous to, and may be referred to as, client, mobile, mobile device, mobile terminal, user terminal, mobile unit, mobile station, mobile user, subscriber, user, remote station, access agent, user agent, receiver, radio equipment, reconfigurable radio equipment, or reconfigurable mobile device. Furthermore, the term “user equipment” or “UE” may include any type of wireless/wired device or any computing device, including a wireless communications interface.

The term “computer system,” as used herein, refers to any type of interconnected electronic devices, computer devices, or components thereof. Additionally, the term “computer system” or “system” may refer to various components of a computer that are communicatively coupled with one another. Furthermore, the term “computer system” or “system” may refer to multiple computer devices or multiple computing systems that are communicatively coupled with one another and configured to share computing or networking resources.

The term “channel,” as used herein, refers to any transmission medium, either tangible or intangible, that is used to communicate data or a data stream. The term “channel” may be synonymous with or equivalent to “communications channel,” “data communications channel,” “transmission channel,” “data transmission channel,” “access channel,” “data access channel,” “link,” “data link,” “carrier,” “radio-frequency carrier,” or any other like term denoting a pathway or medium through which data is communicated. Additionally, the term “link,” as used herein, refers to a connection between two devices for the purpose of transmitting and receiving information.

The term “connected” may mean that two or more elements at a common communication protocol layer have an established signaling relationship with one another over a communication channel, link, interface, or reference point.

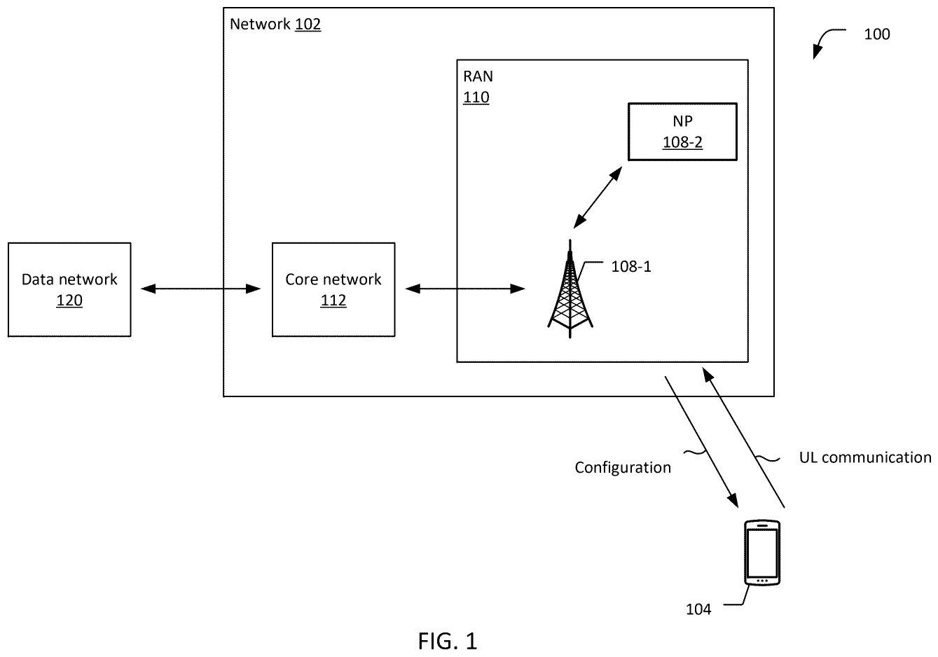

FIG. 1 illustrates a network environment 100 in accordance with some embodiments. The network environment 100 may include a UE 104 communicatively coupled with a radio access network (RAN) 110. RAN 110 may include various network nodes such as base stations, transmit-receiver points (TRPs), etc., to facilitate the provision of one or more serving cells that provide user plane and control plane protocol terminations toward UE 104. In some embodiments, RAN 110 may include a base station 108-1. UE 104 and the base station 108-1 may communicate over air interfaces compatible with 3GPP TSs, such as those that define a Fifth Generation (5G) new radio (NR) system or a later system. The base station 108-1 may provide user plane and control plane protocol terminations toward the UE 104.

Network environment 100 may employ one or more non-terrestrial components and may, therefore, be referred to as a non-terrestrial network (NTN). In an NTN network, RAN 110 may include non-terrestrial nodes, which may also be referred to as NTN payloads (NPs), to provide transmission/reception services with respect to the UE 104. For example, NP 108-2 may provide radio access services through one or more serving cells for UE's geographical area.

The network environment 100 may further include a core network 112. For example, the core network 112 may comprise a 5th Generation Core network (5GC) or a later generation core network. The core network 112 may be coupled to the base station 108-1 via a fiber optic or wireless backhaul. The core network 112 may provide functions for the UE 104 via the base station 108-1 or NP 108-2. These functions may include managing subscriber profile information, subscriber location, authentication of services, or switching functions for voice and data sessions.

The network environment 100 may further include a data network 120. Data network 120 may include a system of interconnected nodes that facilitate data transmission between UE 104 and various application servers and other service providers. The base station 108-1 or NP 108-2 and the core network 112 may route application data between the UE 104 and external data network 120 or application servers. These application servers host web applications, cloud storage, and multimedia streaming services, which communicate with the UE 104 via standardized protocols and interfaces defined by 3GPP, ensuring secure and efficient data exchange.

In some embodiments, NP 108-2 may facilitate the provision of an access link to the serving cells. The NP 108-2 device may be an earth-fixed satellite (such as a geosynchronous (GEO) earth orbit satellite or a high-altitude platform station (HAPS)), a quasi-earth-fixed satellite (such as a non-geostationary Earth orbit (NGEO) satellite with steerable beam), or an Earth-moving satellite (such as an NGEO with fixed or non-steerable beam). The NP 108-2 may facilitate a wireless connection between the base station 108-1 and UE 104 by relaying signals between the two network devices. The signals may be relayed over a feeder link between the NP 108-2 and the base station 108-1 and a service link between the NP 108-2 and UE 104.

NP 108-2, in some embodiments, may be a network node embarked on board the satellite or high-altitude platform station, providing connectivity functions between the service link and the feeder link. If the NP 108-2 functions as a transparent relay, it may be referred to as a transparent NP.

Satellite communication systems may operate in different frequency ranges. The choice of operating frequency may be based on their intended applications. In some instances, the satellite may operate in a first frequency band, e.g., approximately between 1.5 Giga Hertz (GHz) and 2.5 GHz. These frequencies are particularly advantageous for hand-held devices, such as smartphones and tablets, due to their propagation characteristics, which enable better penetration through obstacles like buildings and foliage and facilitate more reliable connectivity in various environments. The second frequency range may span roughly from 10 GHz to 20 GHz. These frequencies may be used for Customer Premises Equipment (CPE) and Fixed Wireless Access (FWA) devices. The second frequency range may offer greater bandwidth and capacity and may be used for stationary or semi-stationary devices due to their line-of-sight requirements and susceptibility to atmospheric attenuation.

3GPP may offer three major technologies for satellite communication, each catering to different needs and applications. The first technology is 5G/NR-based Non-Terrestrial Network communication, which is based on the 5G New Radio (NR) framework with additional enhancements specifically designed for NTN. This technology aims to provide rich communication services, offering a channel bandwidth of 30 Mega Hz (MHz), which can be extended up to 100 MHz, thus supporting high-capacity and high-throughput applications.

The second technology is Fourth generation (4G)/Long-Term Evolution (LTE) CatM-based NTN communication. CatM may be referred to as LTE-M or LTE for machine-type communication, which is a technology designed for Internet of Things (IoT) applications. This technology is built upon the 4G LTE CatM framework with specific enhancements for NTN. Its purpose is to facilitate basic communication and data exchange services. It has a channel bandwidth of 1.4 MHz, making it suitable for applications that require low data rates but still benefit from wide coverage and robust connectivity.

The third technology is 4G/LTE Narrow Band (NB)-IoT-based NTN communication. This system is based on the higher protocols of 4G LTE and the physical layer (PHY) specifically designed for Narrowband Internet of Things (NB-IOT). Its purpose is to support basic IoT-like communication, focusing on connectivity for devices with minimal data throughput requirements. It features a narrow channel bandwidth of 200 kHz, which is ideal for IoT applications where low power consumption and extended coverage are crucial.

Performance, e.g., data rate or error rate, or the uplink communication link between UE 104 and RAN 110 may depend on the UE's output power and the power loss between UE 104 and RAN 110. The power loss between UE 104 and RAN 110 may depend on the antenna gains at UE 104 and RAN 110 and the path loss. Path loss may refer to the reduction in power as it propagates through space from the transmitter (e.g., UE 104) to the receiver (e.g., RAN 110). Path loss may be influenced by various factors, including the distance between the transmitter and the receiver, the frequency of the signal, and the environment through which the signal travels.

Path loss may depend on the frequency of the signal. Atmospheric absorption may be different for each frequency range. Path loss may also depend on the distance between the UE 104 and the RAN 110. For example, in the NTN, path loss may depend on the satellite altitude, e.g., low earth orbit (LEO) satellites at 600 or 1200 kilometers (km) or geostationary earth orbit (GEO) at 35,786 km. In the NTN, path loss may also depend on elevation angle. For example, the shortest distance between UE 104 and NP 108-2 may occur when the satellite is a zenith. The distance between UE 104 and NP 108-2 may increase at elevation angles lower than the zenith.

Frequencies used for uplink (UL) or downlink (DL) communications are often next to other frequency bands used for other applications. For example, NTN frequencies may be next to frequencies used by the Global Navigation Satellite System (GNSS). Requirements or guidelines may regulate the out-of-band emission limits. To meet the out-of-band emission requirements, UE 104 may have to implement high-quality factor filters or reduce its maximum output power to comply with regulatory requirements and guidance. The reduction of maximum output power from the nominal maximum power may be referred to as a power back-off.

Reducing the transmit power by UE 104 reduces the received power at RAN 110 (e.g., base station 108-1 or NP 108-2). In some instances, it may take more time or repetition for a message to be successfully received by network 102. The communication link performance may be more impacted in NTN due to the low link budget caused by high path loss and limited output power of UE 104. The signal-to-interference-and-noise ratio (SINR) of the UL communication link in NTN may be very low, causing low data rate and high latency. As a result, it might be difficult to establish a communication link, or an existing communication link may be lost. In addition, the reliability of network service might be compromised.

It is desirable to keep output power at the maximum nominal level. For example, in an emergency situation, e.g., calling an emergency number, UE 104 may benefit from having a transmit power that is equal to (or substantially close to) the nominal maximum power.

In some embodiments, the requirements and configurations associated with power back-off may be relaxed. The relaxations may allow UE 104 to keep its transmit power up to the nominal maximum output power of the power class. The relaxation may be UE-driven or controlled by network 102.

In some embodiments, signaling may allow the network to indicate relaxation to selected limits in certain scenarios (e.g., emergency calls). UE 104 may be enabled to use relaxed requirements or ignore requirements to maximize output power.

UE 104 may include power management components 130 to determine emergency conditions, determining or applying the configurations for the relaxed set of requirements associated with the emergency condition. UE 104 may utilize power control schemes to determine the power level for transmitted signals.

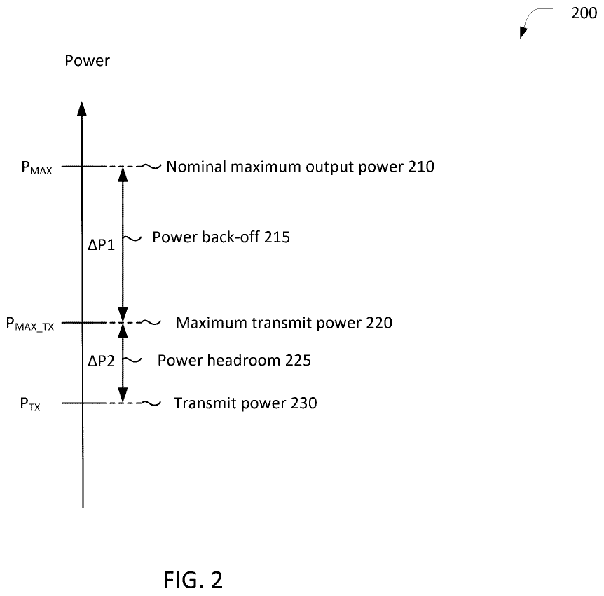

FIG. 2 illustrates a power diagram 200 in accordance with some embodiments. Power diagram 200 illustrates the relationship between the maximum power (e.g., the nominal maximum output power 210) and the actual transmitted power (e.g., transmit power 230).

Nominal maximum output power 210 (PMAX) may be referred to as the maximum power level that UE 104 is designed to transmit. UE 104 may be classified into a power class. Different UEs may be classified into different power classes. Each power class may have a defined nominal maximum output power. For example, in Long-Term Evolution (LTE), Power Class 3 UEs may have a maximum output power of 23 dBm (decibels relative to one milliwatt). This means that Class 3 UE may transmit at a power level up to 23 dBm. In some instances, nominal maximum output power 210 defines the maximum output power under normal operating conditions. The normal operating condition may refer to the standard or typical environmental or functional parameters under which UE 104 is expected to operate. Normal operating conditions may include environmental factors such as temperature or humidity, power supply parameters such as voltage or battery level, network conditions including signal strength or interference levels, or functional loads such as data transmission load or processing load.

For example, normal operating conditions may include operating at temperatures between −10° C. to +45° C., batter level above 20% when the device is within a typical coverage area with moderate signal strength, and encountering normal interference from other devices but not extreme levels. Under such normal operating conditions, UE 104 should be able to transmit at its nominal maximum output power (e.g., 23 dBM for Power Class 3). The nominal maximum output power for different power classes may be specified in 3GPP technical specifications (TSs).

In some embodiments, UE 104 may not be permitted to transmit at a power higher than the nominal maximum output power 210, even under non-normal operating conditions. Transmitting at a power level higher than the nominal maximum output power 210 may violate regulator requirements, risk device integrity, or disrupt network performance.

Maximum transmit power 220 may be the highest power level that a UE (e.g., UE 104) is capable of transmitting under specified conditions. Specified conditions may include considering all applicable reductions and constraints, such as power reductions applied for compliance with requirements. Power back-off 215, ΔP1, may represent the total power reduction, which is applied to the nominal maximum output power of 210 to obtain the maximum transmit power of 220. The power back-off 215 may be band or frequency-dependent. Different frequency bands may have different power back-offs.

For example, power back-off 215 may include maximum power reduction (MPR) or additional maximum power reduction (A-MPR). MPR may be applied to ensure compliance with constraints such as out-of-band emissions. A-MPR. MPR and A-MPR values may be pre-specified in 3GPP TSs. In some instances, MPR or A-MPR values may be configured by Network 102. The nominal maximum output power 210 is reduced by the MPR and A-MPR values to determine the maximum transmit power 20.

Transmit power 230 may represent the actual transmit power by UE 104 at a given time. UE 104 may calculate or obtain transmit power 230 by applying power control algorithms and applying power reductions, offsets, or back-offs to the maximum transmit power 220. The difference between the maximum transmit power 220, and the transmit power 230 may be referred to as power headroom 225, ΔP2.

There are various types of requirements that may necessitate a reduction in the maximum output power of User Equipment (UE). These requirements can be categorized as 3GPP-specific requirements and non-3GPP requirements.

3GPP requirements may include in-channel requirements, out-of-channel requirements, or in-band or out-of-band transmission requirements. In-channel requirements may impact the concerned mobile network operator (MNO). In-channel requirements may include In-Band Emission (IBE) or equalizer spectrum flatness. Out-of-channel requirements may impact the concerned MNO and neighboring operators. Out-of-channel requirements may include Spectrum Emission Mask (SEM) or Adjacent Channel Leakage Ratio (ACLR). Out-of-band requirements often impact other MNOs and may include 3GPP-defined out-of-band emission limits or UE-to-UE coexistence, such as the protection of terrestrial network downlink (TN DL) from non-terrestrial network uplink (NTN UL).

Other non-3GPP requirements may include stricter SEM defined by regulatory bodies such as the European Telecommunication Standards Institute (ETSI) or Federal Communications Commission (FCC), out-of-band emission limits protecting other services (e.g., Global Navigation Satellite System (GNSS) services), and Specific Absorption Rate (SAR) limits. These various requirements, whether internal to 3GPP, in-channel, out-of-channel, out-of-band, or non-3GPP, contribute to determining the maximum transmit power 220 of UE 104 and may provide compliance with both technical and regulatory standards.

If these requirements are relaxed, the UE may maintain its transmission power up to the nominal maximum output power 210.

In some embodiments, UE 104 may apply relaxed requirements without any indication from the network. Such a relaxation may be referred to as UE-driven relaxation. Network 102 may control whether UE 104 relaxes its requirements in other embodiments. Such a relaxation may be referred to as network-controlled relaxation.

Network 102 may activate or enable UE 104 to relax requirements in network-controlled relaxation, contributing to power back-off 215 or power headroom 225. UE 104 may be configured with one or more configurations associated with a power back-off level. Network 102 may configure and identify a configuration to be applied by UE 104. For example, upon initial access, UE 104 may use requirements as signaled by network 102. Depending on the network load or other conditions, network 102 may override UE's requirement.

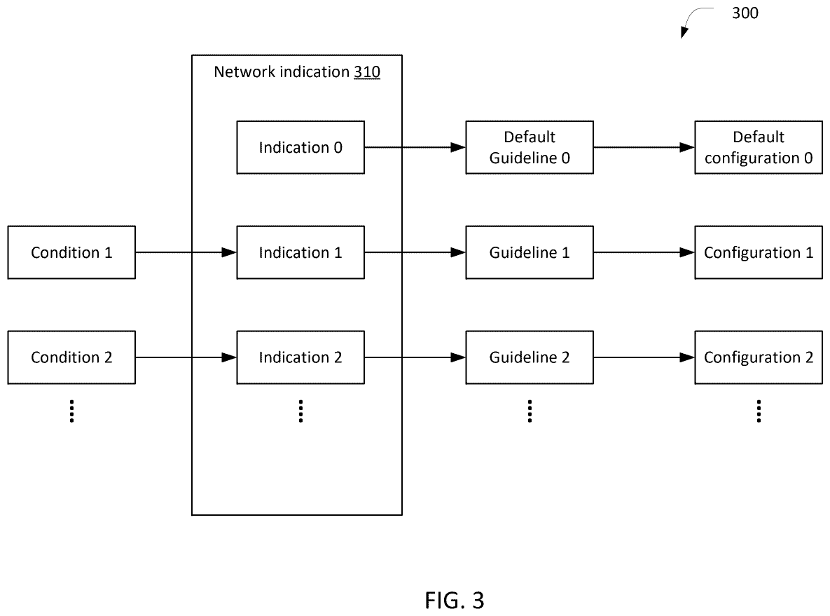

FIG. 3 illustrates a network-controlled relaxation 300 in accordance with some embodiments. Network-controlled relaxation 300 may be an example of a network-controlled approach for relaxing requirements at UE 104.

In network-controlled relaxation 300, network 102 may send network indication 310 to UE 104. Network indication 310 may include one or more indications, e.g., indications 0, 1, 2, . . . . Each indication of network indication 310 may be associated with a condition. For example, network 102 may use indication 1 in response to detecting condition 1 or indication 2 when condition 2 has occurred or met. In one example, conditions (e.g., conditions 1, 2, . . . ) may be associated with detecting a call to an emergency number or a packet or data associated with a high-priority service data flow.

Each indication of network indication 310 may be associated with a set of requirements or guidelines. Each set of requirements or guidelines may be associated with a power back-off level. Each power back-off level may be associated with a configuration that, when applied by UE 104, achieves the power back-off level.

For example, under normal conditions, upon initial access, or when no condition is detected, network indication 310 may include indication 0. Indication 0 may be associated with default requirements or guidelines 0. The default requirement or guideline 0 may be associated with a default configuration 0, where the default configuration may be associated with a default power back-off level.

In one example, condition 1 may be associated with a call to an emergency number. Upon detection of condition 1, network 102 may send indication 1 in network indication 310 to UE 104. Indication 1 may be associated with guideline 1, which in turn may be associated with configuration 1. By applying configuration 1, UE 1 may relax the requirements and restrictions, reduce the power back-off level, and increase the maximum transmit power level, allowing UE 104 to achieve a higher transmit power. A higher transmit power level may be beneficial for making a call to an emergency number, providing a communication link with a higher SINR (compared to default configuration) that could deliver a higher data rate or higher reliability.

In some embodiments, 3GPP specifications may determine or specify the association between condition (e.g., conditions 1, 2, . . . ), network indication 310 (e.g., indication 0, 1, . . . ), guidelines or requirements (e.g., guidelines 0, 1, 2, . . . ), or the configuration (e.g., configurations 0, 1, 2, . . . ).

In some instances, network 102 may configure UE 104 with the association between conditions and network indication 310, between network indication 310 and guidelines or requirements, and between guidelines and requirements and configurations. For example, network 102 may use radio resource control (RRC) signaling to configure the above-mentioned associations.

In some embodiments, UE 104 may indicate to network 102 a capability to adjust or relax requirements or power back-off. For example, UE 104 may generate and send a UE capability report to network 102 to indicate that UE 104 supports or can adjust or relax requirements or power back-off. In some embodiments, network 102 may send an indication to activate or enable the requirement relaxation feature (or power back-off reduction feature) at UE 104. In some instances, the indication is common and cell-specific, which may be applied to all UEs in a cell. A cell-specific activation may be broadcasted, e.g., using a physical broadcast channel (PBCH) or included in a system information block (SIB). In other instances, the indication may be a UE-specific indication.

In some embodiments, network 102 may use SIB-based signaling and include network indication 310 in an SIB. For example, network signaling (NS) flags in SIB may be used for network indication 310 to indicate the set of guidelines, requirements, or configurations.

In some embodiments, using NS flags to relax requirements in an NTN may involve several considerations based on the satellite's configuration and the geographical locations of UE 104. The satellite may provide multiple beam zones, and depending on the geographical locations, network 102 may decide which NS flags to broadcast or not broadcast in relation to the UE's location. For instance, if the NTN band has strict requirements to protect neighboring terrestrial bands, the corresponding NS flags can be omitted in areas where there are no terrestrial deployments. Similarly, some requirements can be relaxed if the NTN beam or cell operates in a remote area. As an example, the requirements for emergency calls can be relaxed in remote or rural areas while maintaining those requirements in urban areas.

Regarding the types of NS flags used to relax requirements, specialized NS flags can be used to indicate relaxation for emission requirements. An NS flag for specific regional requirements may indicated from the network using legacy mechanics. A new signaling option may allow the network to indicate relaxation to selected limits in certain scenarios, such as during an emergency call. In these scenarios, the UE is permitted to use relaxed requirements or even ignore certain requirements to maximize output power. This approach may allow network 102 to dynamically adjust the requirements based on the specific conditions and needs, improving efficiency and compliance with regulatory and technical standards.

Network 102 may use network indication 310 to enable or disable several sets of requirements. Network 102 may indicate which set(s) is (are) applicable. NS flag may include a default set of requirements. The default set may be applied if no other condition is met or if no other condition is enabled by the network. NS flag (e.g., network indication 310 implemented using NS flag) may include one or more sets of alternative requirements that are linked to specific conditions or configurations. Upon reception of the NS flag (e.g., network indication 310), UE 104 may apply the set of requirements or configurations associated with the flag or indication.

In some embodiments, the network signaling for network indication 310 may be a bitmap indicating which of the alternative sets of guidelines or requirements can be used by UE 104 if the condition is met. For example, the bitmap may enable or activate the default set of requirements by setting indication 0 and may enable association between condition 1 and guideline 1 or configuration 1 by setting indication 1 (e.g., setting indication 1 to ‘1’), and may not activate, deactivate, or disable association between condition 2 and guideline 2 or configuration 2 by not setting the indication 2 in network indication 310 (e.g., by setting indication 2 to ‘0’).

In some embodiments, network 102 may configure the association between conditions and a set of requirements or configurations. Upon detecting the condition by the UE 104, UE 104 may apply the corresponding set of requirements or configurations.

For example, an emergency call may be associated with condition 1, condition 1 associated with guideline 1, or an associated set of requirements or configurations (e.g., configuration 1 and network indication 310 have enabled activated or enabled this association. Upon detecting an emergency call at UE 104, guideline 1 or configuration 1 requirements are applied, allowing relaxation of requirements and increasing the maximum transmit power limit.

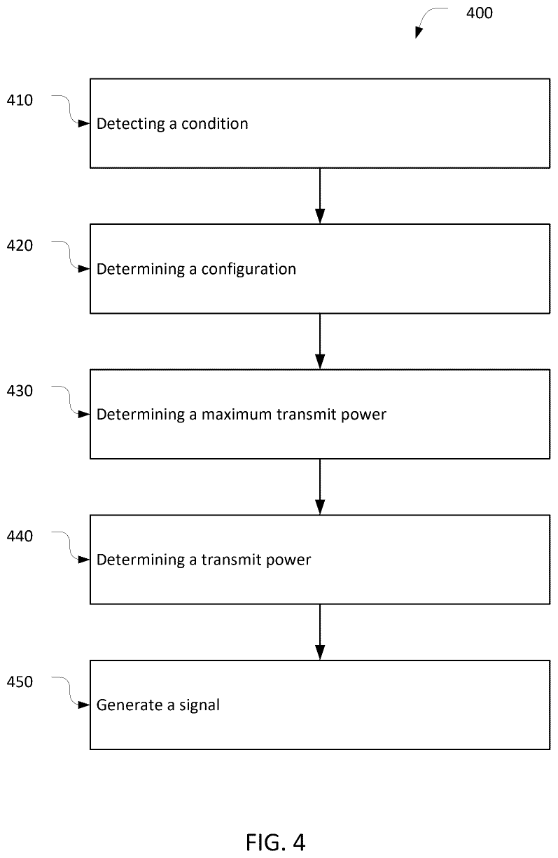

FIG. 4 illustrates an operation flow/algorithmic structure 400 in accordance with some embodiments. The operation flow/algorithmic structure 400 may be an example of a UE-driven requirement relaxation operation. The operation flow/algorithmic structure 400 may be performed or implemented by a UE such as, for example, the UE 104 or UE 700; or components thereof, for example, baseband processor circuitry 704A.

The operation flow/algorithmic structure 400 may include, at 410, detecting a condition. UE 104 may detect a condition. The condition may include an emergency situation, e.g., a call to an emergency number, data associated with an emergency number, a packet associated with an emergency indication or high-priority flag, or an indication from an upper layer that a session is critical as decided by the serving operator. In some embodiments, the condition may be associated with signal transmission to an NTN, e.g., NP 108-2.

For example, initiating a connection with an emergency number (e.g., a number or address associated with a police department, fire department, or local, national, or international emergency numbers or addresses) may be detected by UE 104. The data and control information associated with such a connection may be associated with an importance indication, an emergency indication, a high-priority flat, or a priority index indicating high-priority traffic. For example, the data or control information of the connection may be associated with a packet data unit (PDU) Set. The PDU Set Importance (PSI) parameter may indicate that the PDUs of this PDU Set are associated with an emergency condition. In some instances, one or more quality of service (QoS) parameters of the application data or control traffic may indicate that traffic is associated with an emergency condition or has high priority.

The operation flow/algorithmic structure 400 may include, at 420, determining a configuration. The configuration may be associated with relaxed requirements or guidelines associated with determining maximum transmit power or power back-off. UE 104 may receive and process one or more configurations from network 102. Network 102 (e.g., base station 108-1 or NP 108-2) may generate and send one or more configurations to UE 104. Each configuration of one or more configurations may implicitly or explicitly be associated with a condition. For example, a first condition may be associated with an emergency situation, a second configuration may be associated with initiating or establishing a call to an emergency number, a third condition may be associated with high-priority packets, etc.

In some embodiments, UE 104 may determine the configuration based on the detected condition. The configuration may include parameters associated with requirements, guidelines, or parameters for determining the power back-off or maximum transmit power. For example, the configuration may include, among other relevant parameters, one or more parameters that are explicitly or implicitly associated with a maximum out-of-band emission power, MPR, A-MPR, SEM, adjacent channel power (ACP), adjacent channel leakage ratio (ACLR), or error magnitude (EVM) thresholds or configurations.

In some embodiments, one or more configurations are predefined in 3GPP TSs. In some embodiments, network 102 may configure UE 104 with one or more configurations. For example, network 102 may use system information (SI) or SIB to configure one or more configurations. In another example, network 102 may use RRC signaling to configure one or more configurations.

In some embodiments, regardless of whether one or more configurations are predefined in the 3GPP specifications or are configured by network 102, network 102 may enable or activate a subset of one or more configurations. Network 102 may enable or activate all of the configurations or enable or activate none of them. For example, network 102 may use cell-specific signaling, e.g., using system information (SI) or system information block (SIB) signaling to enable or activate some of the configurations of one or more configurations. In some instances, network 102 may use RRC signaling to enable or activate (or disable or deactivate) a subset of configurations of one or more configurations.

The operation flow/algorithmic structure 400 may include, at 430, determining a maximum transmit power. UE 104 may determine or identify a nominal maximum output power, e.g., based on UE's power class. Based on the configuration determined in 420, UE 104 may determine power back-off. UE 104 may determine the maximum transmit power based on the nominal maximum output power and the power back-off. For example, the maximum transmit power may be obtained by subtracting the power back-off from the nominal maximum output power. The maximum transmit power may exceed the maximum transmit power associated with a default configuration (e.g., UE's default or initial configuration).

In some embodiments, UE 104 may generate a report to be transmitted to network 102. The report may include an indication of the condition or the maximum transmit power. In some embodiments, the report may include a flag (e.g., one or more bits) indicating the network 102 that the UE has changed or relaxed some of the requirements or guidelines associated with calculating maximum output power, e.g., requirements associated with determining power back-off.

The operation flow/algorithmic structure 400 may include, at 440, determining a transmit power. UE 104 may use the determined transmit power for a signal transmission. UE 104 may apply power control (e.g., open-loop or closed-loop power control) to determine the transmit power. The transmit power may be restricted by the maximum transmit power, e.g., the transmit power may not exceed the maximum transmit power. In some instances, the transmit power may be equal to the maximum transmit power. In some instances, the configuration may relax all the requirements and guidelines, allowing the maximum transmit power to be the same as the nominal maximum output power, e.g., eliminating all power back-offs.

The operation flow/algorithmic structure 400 may include, at 450, generating a signal. UE 104 may generate and transmit the signal. The power level of the signal is equal to the transmit power level, which is determined in 440. UE 104 may transmit the generated signal to base station 108-1 or NP 108-2.

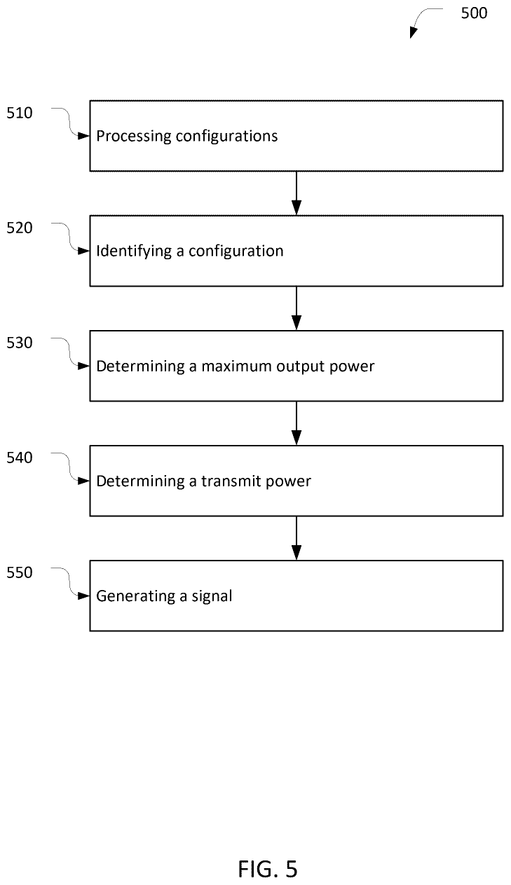

FIG. 5 illustrates an operation flow/algorithmic structure 500 in accordance with some embodiments. The operation flow/algorithmic structure 400 may be an example of a network-controlled requirement relaxation operation. The operation flow/algorithmic structure 500 may be performed or implemented by a UE such as, for example, the UE 104 or UE 700; or components thereof, for example, baseband processor circuitry 704A.

The operation flow/algorithmic structure 500 may include, at 510, processing one or more configurations. The configurations may be associated with determining maximum transmit powers for signal transmission to a terrestrial network, e.g., base station 108-1, or an NTN, e.g., NP 108-2. UE 104 may identify one or more configurations associated with determining the maximum transmit power, power back-offs, or requirements or guidelines associated with power transmission. UE 104 may receive and process one or more configurations from network 102. For example, network 102 may generate and transmit one or more configurations using SI, SIB, or RRC signaling. In some instances, the configurations may be defined in 3GPP TSs.

In some embodiments, the configurations are implicitly associated with a condition or are default configurations. The condition may be an emergency situation, e.g., a call to an emergency number, data associated with an emergency number, packets associated with an emergency indication or a high-priority flag, or an indication from an upper layer that a session is critical.

In some embodiments, each configuration (of the received configurations) may explicitly identify a condition. For example, the configuration may include a field whose value is an index associated with a condition.

In some embodiments, each configuration (of the received configurations) may implicitly or explicitly be associated with a set of requirements or guidelines related to determining power back-off or maximum transmit power. For example, the set of requirements may define the level of out-of-band emission. The out-of-band emission level may determine the power back-off (in dB or dBm) that the UE 104 has to apply to the nominal maximum output power. The relationship between the out-of-band emission and the corresponding power back-off may be configured (e.g., by network 102) or defined in the 3GPP TSs. In some instances, the configuration may include the index associated with a set of requirements or guidelines. In some instances, the configuration may include one or more fields associated with each requirement and parameters that are configured by the configuration.

The operation flow/algorithmic structure 500 may include, at 520, identifying a configuration. UE 104 may identify a configuration from the one or more configurations that were received and processed at 510.

In some embodiments, all the received configurations are assumed to be activated and enabled. For example, upon detecting a condition, UE 104 may identify, select, and apply the corresponding configuration.

In the network-controller approach, network 102 may select and signal UE 104, a configuration to be selected and applied. For example, upon detecting a condition, UE 104 may generate and send a report to network 104, including an indication of the condition. Network 102 may select a configuration based on the indication of the condition and send a message including an indication of the configuration (e.g., the configuration index) to UE 104. In some instances, network 102 may detect the condition from information associated with received packets associated with UE 104, e.g., from the PSI or priority information.

In some embodiments, network 102 may use a bitmap indicating which of the alternative sets of requirements or guidelines can be used by the UE when a condition is met. For example, each bit in the bitmap may be associated with a set of requirements or configurations associated with a condition. If a bit in the bitmap is set, e.g., has a value of ‘1’, the corresponding set of requirements is configured, and upon detection of the associated condition, UE 104 may apply the requirement. However, if a bit in the bitmap is not set, e.g., has a value of ‘0’, the corresponding set of requirements is not configured, and upon detection of the associated condition, UE 104 may not apply those requirements.

In some embodiments, the configurations may include a default configuration. UE 104 may apply the default configuration upon initial connection, registration, or in response to any condition that results in ambiguity in identifying a configuration.

The operation flow/algorithmic structure 500 may include, at 530, determining a maximum output power. Operation flow/algorithmic structure 500 at 530 is similar to the operation flow/algorithmic structure 400 at 430.

The operation flow/algorithmic structure 500 may include, at 540, determining a transmit power. Operation flow/algorithmic structure 500 at 540 is similar to the operation flow/algorithmic structure 400 at 440.

The operation flow/algorithmic structure 500 may include, at 550, generating a signal. Operation flow/algorithmic structure 500 at 550 is similar to the operation flow/algorithmic structure 400 at 450.

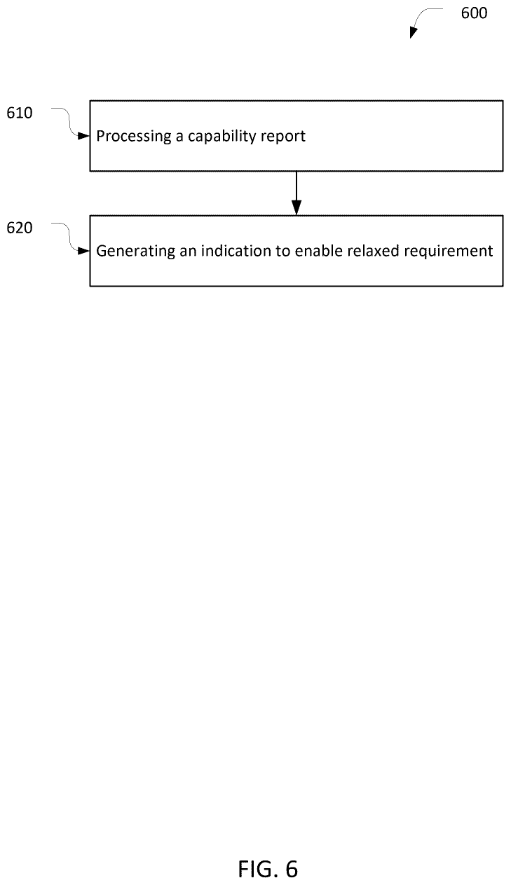

FIG. 6 illustrates an operational flow/algorithmic structure 600 in accordance with some embodiments. The operation flow/algorithmic structure 600 may be performed or implemented by a base station such as, for example, the base station 108-1, NP 108-2, or the base station 800; or components thereof, for example, baseband processor circuitry 804A.

The operation flow/algorithmic structure 600 may include, at 610, the process of a capability report. UE 104 may generate and send a capability report to network 102, and network 102 may receive and process the capability report sent by UE 104. The capability report may indicate that the UE supports relaxed requirement operations associated with determining power back-off or determining a maximum transmit power. For example, the capability report may be included in the UE capability report or may be indicated with UE preference information.

The operation flow/algorithmic structure 600 may include, at 620, generating an indication to enable relaxed requirement operation. Based on the capability report, network 102 may generate and send a message to UE 104, where the message includes an indication to enable relaxed requirements operation at UE 104.

In some embodiments, the indication may be a cell-specific indication, enabling all UEs to support relaxed requirement operation. A cell-specific indication may be sent via common signaling, such as those transmitted in a broadcast channel, e.g., PBCH. For example, network 102 may use system information, SIB, or cell-specific RRC signaling to send the indication. In some embodiments, the indication may be a UE-specific indication. Each UE supporting relaxed requirement operation may receive an activation or deactivation indication. For example, network 102 may use dedicated signaling to enable or activate a UE (e.g., UE 104) or disable or deactivate a UE (e.g., UE 104).

In some embodiments, network 102 may determine a condition associated with UE 104. The condition may be an emergency situation, a call to an emergency number, data associated with an emergency number, a packet associated with an emergency indication, or a high-priority flag. In some instances, network 102 may receive and process from UE 104 an indication associated with a condition. In some instances, network 102 may infer the condition from information received from UE 104. For example, the importance parameter associated with PDUs received may indicate the condition. In some embodiments, network 102 may generate and send an activation to activate a configuration associated with the condition. In some examples, once the condition is resolved and is no longer valid, UE 104 may change its configuration to a default configuration. Similarly, once network 102 determines that the condition no longer exists at UE 104, it may deactivate the configuration associated with the condition and may indicate UE 104 to activate or apply the default configuration.

In some embodiments, network 102 may enable or disable relaxed requirement operation based on the geographical area. In some instances, network 102 may enable or disable the relaxed requirement operation of UE 104 based on the geographical location of the UE 104. UE 104 may be configured with several configurations or sets of requirements or guidelines, and network 102 may enable or activate only a subset of the configured configurations or set of requirements or guidelines. In some embodiments, the activation or deactivation, or enabling or disabling, the relaxed requirement operation may depend on the network condition, such as payload or congestion.

In some embodiments, UE 104 may perform cell selection or cell reselection, initial access, or handover operations based on whether the target cell supports or provides relaxed requirement operation.

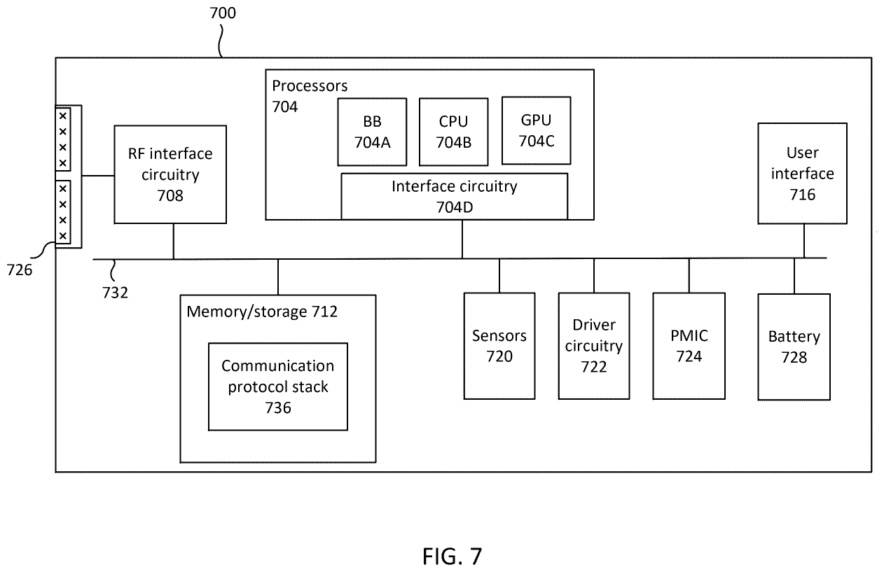

FIG. 7 illustrates a UE 700 in accordance with some embodiments. The UE 700 may be similar to and substantially interchangeable with the UE 104.

The UE 700 may be any mobile or non-mobile computing device, such as, for example, mobile phones, computers, tablets, industrial wireless sensors (for example, microphones, carbon dioxide sensors, pressure sensors, humidity sensors, thermometers, motion sensors, accelerometers, laser scanners, fluid level sensors, inventory sensors, electric voltage/current meters, or actuators), video surveillance/monitoring devices (for example, cameras or video cameras), wearable devices (for example, a smartwatch), or Internet-of-things devices.

The UE 700 may include processors 704, RF interface circuitry 708, memory/storage 712, user interface 716, sensors 720, driver circuitry 722, power management integrated circuit (PMIC) 724, antenna 726, and battery 728. The components of the UE 700 may be implemented as integrated circuits (ICs), portions thereof, discrete electronic devices, or other modules, logic, hardware, software, firmware, or a combination thereof. The block diagram of FIG. 7 is intended to show a high-level view of some of the components of the UE 700. However, some of the components shown may be omitted, additional components may be present, and different arrangements of the components shown may occur in other implementations.

The components of the UE 700 may be coupled with various other components over one or more interconnects 732, which may represent any type of interface, input/output, bus (local, system, or expansion), transmission line, trace, or optical connection that allows various circuit components (on common or different chips or chipsets) to interact with one another.

The processors 704 may include processor circuitry such as, for example, baseband processor circuitry (BB) 704A, central processor unit circuitry (CPU) 704B, and graphics processor unit circuitry (GPU) 704C. The processors 704 may include any type of circuitry, or processor circuitry that executes or otherwise operates computer-executable instructions, such as program code, software modules, or functional processes from memory/storage 712 to cause the UE 700 to perform operations as described herein. The processors 704 may also include interface circuitry 704D to communicatively couple the processor circuitry with one or more other components of the UE 700.

In some embodiments, the baseband processor circuitry 704A may access a communication protocol stack 736 in the memory/storage 712 to communicate over a 3GPP-compatible network. In general, the baseband processor circuitry 704A may access the communication protocol stack 736 to: perform user plane functions at a PHY layer, MAC layer, RLC layer, PDCP layer, SDAP layer, and PDU layer; and perform control plane functions at a PHY layer, MAC layer, RLC layer, PDCP layer, RRC layer, and a NAS layer. In some embodiments, the PHY layer operations may additionally/alternatively be performed by the components of the RF interface circuitry 708.

The baseband processor circuitry 704A may generate or process baseband signals or waveforms that carry information in 3GPP-compatible networks. In some embodiments, the waveforms for NR may be based on cyclic prefix OFDM (CP-OFDM) in the uplink or downlink, and discrete Fourier transform spread OFDM (DFT-S-OFDM) in the uplink.

The memory/storage 712 may include one or more non-transitory, computer-readable media that includes instructions (for example, communication protocol stack 736) that may be executed by one or more of the processors 704 to cause the UE 700 to perform various operations described herein.

The memory/storage 712 includes any type of volatile or non-volatile memory that may be distributed throughout the UE 700. In some embodiments, some of the memory/storage 712 may be located on the processors 704 themselves (for example, memory/storage 712 may be part of a chipset that corresponds to the baseband processor circuitry 704A), while other memory/storage 712 is external to the processors 704 but accessible thereto via a memory interface. The memory/storage 712 may include any suitable volatile or non-volatile memory such as, but not limited to, dynamic random access memory (DRAM), static random access memory (SRAM), erasable programmable read-only memory (EPROM), electrically erasable programmable read-only memory (EEPROM), Flash memory, solid-state memory, or any other type of memory device technology.

The RF interface circuitry 708 may include transceiver circuitry and a radio frequency front module (RFEM) that allows the UE 700 to communicate with other devices over a radio access network. The RF interface circuitry 708 may include various elements arranged in transmit or receive paths. These elements may include, for example, switches, mixers, amplifiers, filters, synthesizer circuitry, and control circuitry.

In the receive path, the RFEM may receive a radiated signal from an air interface via antenna 726 and proceed to filter and amplify (with a low-noise amplifier) the signal. The signal may be provided to a receiver of the transceiver that down-converts the RF signal into a baseband signal that is provided to the baseband processor of the processors 704.

In the transmit path, the transmitter of the transceiver up-converts the baseband signal received from the baseband processor and provides the RF signal to the RFEM. The RFEM may amplify the RF signal through a power amplifier prior to the signal being radiated across the air interface via the antenna 726.

In various embodiments, the RF interface circuitry 708 may be configured to transmit/receive signals in a manner compatible with NR access technologies.

The antenna 726 may include antenna elements to convert electrical signals into radio waves to travel through the air and to convert received radio waves into electrical signals. The antenna elements may be arranged into one or more antenna panels. The antenna 726 may have antenna panels that are omnidirectional, directional, or a combination thereof to enable beamforming and multiple input, multiple output communications. The antenna 726 may include microstrip antennas, printed antennas fabricated on the surface of one or more printed circuit boards, patch antennas, or phased array antennas. The antenna 726 may have one or more panels designed for specific frequency bands including bands in FR1 or FR2.

The user interface 716 includes various input/output (I/O) devices designed to enable user interaction with the UE 700. The user interface 716 includes input device circuitry and output device circuitry. Input device circuitry includes any physical or virtual means for accepting an input including, inter alia, one or more physical or virtual buttons (for example, a reset button), a physical keyboard, keypad, mouse, touchpad, touchscreen, microphones, scanner, headset, or the like. The output device circuitry includes any physical or virtual means for showing information or otherwise conveying information, such as sensor readings, actuator position(s), or other like information. Output device circuitry may include any number or combinations of audio or visual display, including, inter alia, one or more simple visual outputs/indicators (for example, binary status indicators such as light emitting diodes (LEDs) and multi-character visual outputs, or more complex outputs such as display devices or touchscreens (for example, liquid crystal displays (LCDs), LED displays, quantum dot displays, and projectors), with the output of characters, graphics, multimedia objects, and the like being generated or produced from the operation of the UE 700.

The sensors 720 may include devices, modules, or subsystems whose purpose is to detect events or changes in their environment and send the information (sensor data) about the detected events to some other device, module, or subsystem. Examples of such sensors include inertia measurement units comprising accelerometers, gyroscopes, or magnetometers; microelectromechanical systems or nanoelectromechanical systems comprising 3-axis accelerometers, 3-axis gyroscopes, or magnetometers; level sensors; flow sensors; temperature sensors (for example, thermistors); pressure sensors; barometric pressure sensors; gravimeters; altimeters; image capture devices (for example, cameras or lensless apertures); light detection and ranging sensors; proximity sensors (for example, infrared radiation detector and the like); depth sensors; ambient light sensors; ultrasonic transceivers; and microphones or other like audio capture devices.

The driver circuitry 722 may include software and hardware elements that operate to control particular devices that are embedded in the UE 700, attached to the UE 700, or otherwise communicatively coupled with the UE 700. The driver circuitry 722 may include individual drivers allowing other components to interact with or control various input/output (I/O) devices that may be present within or connected to the UE 700. For example, driver circuitry 722 may include a display driver to control and allow access to a display device, a touchscreen driver to control and allow access to a touchscreen interface, sensor drivers to obtain sensor readings of sensors 720, and control and allow access to sensors 720, drivers to obtain actuator positions of electro-mechanic components or control and allow access to the electro-mechanic components, a camera driver to control and allow access to an embedded image capture device, audio drivers to control and allow access to one or more audio devices.

The PMIC 724 may manage power provided to various components of the UE 700. In particular, with respect to the processors 704, the PMIC 724 may control power-source selection, voltage scaling, battery charging, or DC-to-DC conversion.

A battery 728 may power the UE 700, although in some examples, the UE 700 may be mounted deployed in a fixed location and may have a power supply coupled to an electrical grid. The battery 728 may be a lithium-ion battery, a metal-air battery, such as a zinc-air battery, an aluminum-air battery, a lithium-air battery, and the like. In some implementations, such as in vehicle-based applications, the battery 728 may be a typical lead-acid automotive battery.

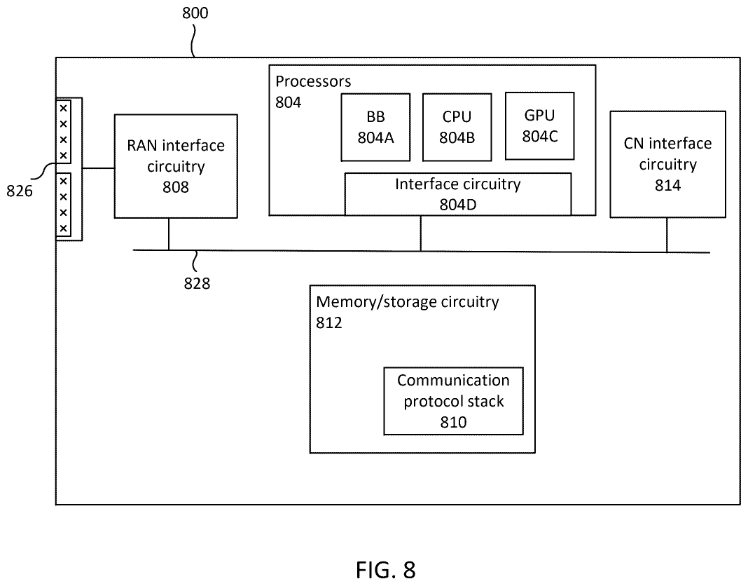

FIG. 8 illustrates a network device 800 in accordance with some embodiments. The network device 800 may be similar to and substantially interchangeable with base station 108.

The network device 800 may include processors 804, RF interface circuitry 808 (if implemented as a base station), core network (CN) interface circuitry 814, memory/storage circuitry 812, and antenna structure 826.

The components of the network device 800 may be coupled with various other components over one or more interconnects 828.

The processors 804, RF interface circuitry 808, memory/storage circuitry 812 (including communication protocol stack 810), antenna structure 826, and interconnects 828 may be similar to like-named elements shown and described with respect to FIG. 7.

The processors 804 may include processor circuitry such as, for example, baseband processor circuitry (BB) 804A, central processor unit circuitry (CPU) 804B, and graphics processor unit circuitry (GPU) 804C. The processors 804 may include any type of circuitry or processor circuitry that executes or otherwise operates computer-executable instructions, such as program code, software modules, or functional processes from memory/storage circuitry 812 to cause the UE 700 to perform operations as described herein. The processors 804 may also include interface circuitry 804D to communicatively couple the processor circuitry with one or more other components of the network device 800.

The CN interface circuitry 814 may provide connectivity to a core network, for example, a 5th Generation Core network (5GC) using a 5GC-compatible network interface protocol such as carrier Ethernet protocols or some other suitable protocol. Network connectivity may be provided to/from the network device 800 via a fiber optic or wireless backhaul. The CN interface circuitry 814 may include one or more dedicated processors or FPGAs to communicate using one or more of the aforementioned protocols. In some implementations, the CN interface circuitry 814 may include multiple controllers to provide connectivity to other networks using the same or different protocols.

It is well understood that the use of personally identifiable information should follow privacy policies and practices generally recognized as meeting or exceeding industry or governmental requirements for maintaining users'privacy. In particular, personally identifiable information data should be managed and handled so as to minimize risks of unintentional or unauthorized access or use, and the nature of authorized use should be clearly indicated to users.

For one or more embodiments, at least one of the components set forth in one or more of the preceding figures may be configured to perform one or more operations, techniques, processes, or methods as set forth in the example section below. For example, the baseband circuitry described above in connection with one or more of the preceding figures may be configured to operate according to one or more of the examples set forth below. For another example, circuitry associated with a UE, base station, or network element described above in connection with one or more of the preceding figures may be configured to operate according to one or more of the examples set forth below in the example section.

### EXAMPLES

In the following sections, further exemplary embodiments are provided.

Example 1 includes a method including: detecting a condition; determining, based on the condition, a configuration from one or more configurations; determining a maximum transmit power based on the configuration; determining, based on the maximum transmit power, a transmit power; and generating a signal to be transmitted with a power equal to the transmit power.

Example 2 includes the method of example 1 or some other examples herein, wherein the condition includes: an emergency situation; a call to an emergency number; data associated with an emergency number; or a packet associated with an emergency indication or a high-priority flag.

Example 3 includes the method of examples 1 or 2 or some other examples herein, wherein the configuration includes a parameter associated with a maximum out-of-band emission power.

Example 4 includes the method of any of examples 1-3 or some other examples herein, wherein said determining a maximum transmit power based on the configuration includes: identifying a nominal maximum output power; determining a power back-off based on the configuration; and determining the maximum transmit power based on the nominal maximum output power and the power back-off.

Example 5 includes the method of any of examples 1-4 or some other example herein, further including: generating a report, to be transmitted to a base station, including an indication of the configuration or the maximum transmit power.

Example 6 includes the method of any of examples 1-5 or some other example herein, wherein the maximum transmit power is equal to a nominal maximum output power or the transmit power is equal to the maximum transmit power.

Example 7 includes a method including: processing one or more configurations associated with determining a maximum transmit power; identifying a configuration of the one or more configurations; determining the maximum transmit power based on the configuration; determining, based on the maximum transmit power, a transmit power; and generating a signal to be transmitted with a power equal to the transmit power.

Example 8 includes the method of example 7 or some other examples herein, wherein the configuration is a default configuration.

Example 9 includes the method of examples 7 or 8 or some other examples herein, wherein the one or more configurations are included in a system information block (SIB); and the SIB includes a bitmap to determine the one or more configurations.

Example 10 includes the method of any of examples 7-9 or some other examples herein, further including: processing an indication, wherein to identify a configuration of the one or more configurations the processing circuitry is to identify the configuration of the one or more configurations based on the indication.

Example 11 includes the method of any of examples 7-10 or some other examples herein, wherein the configuration is a first configuration, and the method further includes: detecting a condition associated with a second configuration of the one or more configurations; and generating, for transmission to a base station, an indication associated with the condition or the second configuration.

Example 12 includes the method of any of examples 7-11 or some other examples herein, wherein the condition includes: an emergency situation; a call to an emergency number; data associated with an emergency number; or a packet associated with an emergency indication or a high-priority flag.

Example 13 includes the method of any of examples 7-12 or some other examples herein, and the method further including: generating a user equipment (UE) capability report, to be transmitted to a base station, including an indication of a capability to apply adjust configuration associated with determining the maximum transmit power.

Example 14 includes the method of any of examples 7-13 or some other examples herein, wherein the configuration includes a parameter associated with a maximum out-of-band emission power.

Example 15 includes the method of any of examples 7-14 or some other examples herein, wherein said determining a maximum transmit power based on the configuration includes: identifying a nominal maximum output power; determining a power back-off based on the configuration; and determining the maximum transmit power based on the nominal maximum output power and the power back-off.

Example 16 includes a method including: processing a capability report, received from a user equipment (UE), indicating that the UE supports relaxed requirements operation associated with determining a power back-off or a maximum transmit power; and generating, for transmission to the UE, an indication to enable relaxed requirements operation.

Example 17 includes the method of example 16 or some other examples herein, the method further including: processing an indication, received from the UE, associated with a condition; and generating, based on the condition, an indication of a configuration associated with a set of requirements for determining the power back-off or the maximum transmit power.

Example 18 includes the method of examples 16 or 17 or some other examples herein, wherein the condition includes: an emergency situation; a call to an emergency number; data associated with an emergency number; or a packet associated with an emergency indication or a high-priority flag.

Example 19 includes the method of any of examples 16-18 or some other examples herein, wherein: the indication is included in a system information block (SIB) or a system information (SI).

Example 20 includes the method of any of examples 16-18 or some other examples herein, the indication includes a bitmap and each bit in the bitmap is corresponding to a set of requirements for determining the maximum transmit power or the power back-off.

Another example may include an apparatus comprising means to perform one or more elements of a method described in or related to any of examples 1-20, or any other method or process described herein.

Another example may include one or more non-transitory computer-readable media comprising instructions to cause an electronic device, upon execution of the instructions by one or more processors of the electronic device, to perform one or more elements of a method described in or related to any of examples 1-20, or any other method or process described herein.

Another example may include an apparatus comprising logic, modules, or circuitry to perform one or more elements of a method described in or related to any of examples 1-20, or any other method or process described herein.

Another example may include a method, technique, or process as described in or related to any of examples 1-20, or portions or parts thereof.

Another example may include an apparatus comprising: one or more processors and one or more computer-readable media comprising instructions that, when executed by the one or more processors, cause the one or more processors to perform the method, techniques, or process as described in or related to any of examples 1-20, or portions thereof.

Another example may include a signal as described in or related to any of examples 1-20, or portions or parts thereof.

Another example may include a datagram, information element, packet, frame, segment, PDU, or message as described in or related to any of examples 1-20, or portions or parts thereof, or otherwise described in the present disclosure.

Another example may include a signal encoded with data as described in or related to any of examples 1-20, or portions or parts thereof, or otherwise described in the present disclosure.

Another example may include a signal encoded with a datagram, IE, packet, frame, segment, PDU, or message as described in or related to any of examples 1-20, or portions or parts thereof, or otherwise described in the present disclosure.

Another example may include an electromagnetic signal carrying computer-readable instructions, wherein execution of the computer-readable instructions by one or more processors is to cause the one or more processors to perform the method, techniques, or process as described in or related to any of examples 1-20, or portions thereof.

Another example may include a computer program comprising instructions, wherein execution of the program by a processing element is to cause the processing element to carry out the method, techniques, or process as described in or related to any of examples 1-20, or portions thereof.

Another example may include a signal in a wireless network as shown and described herein.

Another example may include a method of communicating in a wireless network, as shown and described herein.

Another example may include a system for providing wireless communication, as shown and described herein.

Another example may include a device for providing wireless communication, as shown and described herein.

Unless explicitly stated otherwise, any of the above-described examples may be combined with any other example (or combination of examples). The foregoing description of one or more implementations provides illustration and description but is not intended to be exhaustive or to limit the scope of embodiments to the precise form disclosed. Modifications and variations are possible in light of the above teachings or may be acquired from the practice of various embodiments.

Although the embodiments above have been described in considerable detail, numerous variations and modifications will become apparent to those skilled in the art once the above disclosure is fully appreciated. It is intended that the following claims be interpreted to embrace all such variations and modifications.

What is claimed is:

1. A method comprising:
detecting a condition associated with signal transmissions to a network;
determining, based on the condition, a configuration from one or more configurations for the signal transmissions;
determining a first maximum transmit power based on the configuration, the maximum transmit power exceeding a second maximum transmit power associated with a default configuration such that the first maximum transmit power corresponds to a relaxation of requirements on the signal transmissions relative to the default configuration;
determining, based on the maximum transmit power, a transmit power for a signal transmission to the network; and
generating a signal to be transmitted to the network with a power equal to the transmit power.

2. The method of claim 1, wherein the condition includes:
an emergency situation;
a call to an emergency number;
data associated with an emergency number;
a packet associated with an emergency indication or a high-priority flag; or
an indication from an upper layer that a session is critical.

3. The method of claim 1, wherein the configuration includes a parameter associated with an out-of-band or in-band transmission requirements.

4. The method of claim 1, wherein said determining a maximum transmit power based on the configuration comprises:
identifying a nominal maximum output power;
determining a power back-off based on the configuration; and
determining the maximum transmit power based on the nominal maximum output power and the power back-off.

5. The method of claim 1, further comprising:
generating a report, to be transmitted to a base station, including an indication of the configuration or the maximum transmit power.

6. The method of claim 1, wherein the maximum transmit power is equal to a nominal maximum output power or the transmit power is equal to the maximum transmit power.

7. An apparatus comprising:
processing circuitry to:
process one or more configurations associated with determining maximum transmit powers for signal transmissions to a non-terrestrial network (NTN);
identify a configuration of the one or more configurations;
determine a first maximum transmit power based on the configuration, the maximum transmit power exceeding a second maximum transmit power associated with a default configuration such that the first maximum transmit power corresponds to a relaxation of requirements on the signal transmissions relative to the default configuration;
determine, based on the maximum transmit power, a transmit power for a signal transmission to the NTN; and
generate a signal to be transmitted to the NTN with a power equal to the transmit power.

8. The apparatus of claim 7, wherein the configuration is a default configuration.

9. The apparatus of claim 7, wherein:
the one or more configurations are included in a system information block (SIB); and
the SIB includes a bitmap to determine the one or more configurations.

10. The apparatus of claim 7, wherein the processing circuitry is further to:
process an indication, wherein to identify a configuration of the one or more configurations the processing circuitry includes identifying the configuration of the one or more configurations based on the indication.

11. The apparatus of claim 7, wherein the configuration is a first configuration, and the processing circuitry is further to:
detect a condition associated with a second configuration of the one or more configurations; and
generate, for transmission to a base station of the NTN, an indication associated with the condition or the second configuration.

12. The apparatus of claim 11, wherein the requirement includes:
in-band emission (IBE);
spectrum emission mask (SEM);
adjacent channel leakage ratio (ACLR); or
specific absorption rate (SAR).

13. The apparatus of claim 7, wherein the processing circuitry is further to:
generate a user equipment (UE) capability report, to be transmitted to a base station, including an indication of a capability to apply adjust configuration associated with determining the maximum transmit power.

14. The apparatus of claim 7, wherein the configuration includes a parameter associated with a maximum out-of-band emission power.

15. The apparatus of claim 7, wherein to determine a maximum transmit power based on the configuration the processing circuitry is to:
identify a nominal maximum output power;
determine a power back-off based on the configuration; and
determine the maximum transmit power based on the nominal maximum output power and the power back-off.

16. One or more non-transitory computer-readable media having instructions that, when executed, cause processing circuitry to:
process a capability report, received from a user equipment (UE), indicating that the UE supports relaxed requirements operation associated with determining a maximum transmit power for signal transmissions to a non-terrestrial network (NTN); and
generate, for transmission to the UE, an indication to enable relaxed requirements operation for signal transmission to the NTN.

17. The one or more non-transitory computer-readable media of claim 16, wherein the instructions, when executed, further cause the processing circuitry to:
process an indication, received from the UE, associated with a condition with signal transmissions to the NTN; and
generate, based on the condition, an indication of a configuration associated with a set of requirements for determining a first maximum transmit power, the first maximum transmit power exceeding a second maximum transmit power associated with a default configuration such that the first maximum transmit power corresponds to a relaxation of requirements on the signal transmissions relative to the default configuration.

18. The one or more non-transitory computer-readable media of claim 17, wherein:
the condition includes an emergency situation, a call to an emergency number, data associated with an emergency number or a packet associated with an emergency indication or a high-priority flag; and
the set of requirements include: in-band emission (IBE), spectrum emission mask (SEM), adjacent channel leakage ratio (ACLR), or specific absorption rate (SAR).

19. The one or more non-transitory computer-readable media of claim 17, wherein:
the indication is included in a system information block (SIB) or a system information (SI).

20. The one or more non-transitory computer-readable media of claim 17, wherein the indication includes a bitmap and each bit in the bitmap is corresponding to a set of requirements for determining the maximum transmit power or the power back-off.
